(19) United States
(12) Patent Application Publication
(10) Pub. No.: US 2024/0244533 A1
(43) Pub. Date: Jul. 18, 2024

(54) UL GAP TRIGGERING

(71) Applicant: Apple Inc., Cupertino, CA (US)

(72) Inventors: Huaning NIU, San Jose, CA (US); Dawei ZHANG, Saratoga, CA (US); Haijing HU, Los Gatos, CA (US); Jie CUI, San Jose, CA (US); Qiming LI, Beijing (CN); Sharad SAMBHWANI, San Diego, CA (US); Xiang CHEN, Campbell, CA (US); Yang TANG, San Jose, CA (US); Yuqin CHEN, Beijing (CN)

(21) Appl. No.: 17/905,957

(22) PCT Filed: Sep. 24, 2021
(86) PCT No.: PCT/CN2021/120453

§ 371 Date: Sep. 9, 2022

(51) Int. Cl. H04W 52/14; H04B 17/318; H04W 52/02; H04W 52/36; H04W 76/20; H04W 80/02

(52) U.S. Cl. CPC H04W 52/146; H04B 17/328; H04W 52/0245; H04W 52/365; H04W 52/367; H04W 76/20; H04W 80/02

(57) ABSTRACT

Embodiments of the present disclosure relate to uplink (UL) gap triggering. According to embodiments of the present disclosure, a processor of user equipment is configured to perform following operations. The operations comprise transmitting to a network a user preference via a first signaling, wherein the user preference indicates a preference of the UE in uplink (UL) gap configuration; transmitting to the network an UL gap activation request via a second signaling, wherein the UL gap activation request indicates the network that an UL gap activation for the UE is needed; and transmitting to the network device an UL gap deactivation request via a third signaling, wherein the UL gap deactivation request indicates the network that an UL gap deactivation for the UE is needed.

### TECHNICAL FIELD

Embodiments of the present disclosure generally relate to the field of telecommunications, and in particular, to uplink (UL) gap triggering.

### BACKGROUND

Third Generation Partnership Project (3GPP) Fifth Generation (5G) New Radio (NR) provides for communication between user equipment (UE) and a base station, for example, a next generation Node B (gNB). In recent discussion on the NR system, uplink (UL) gap was proposed for self-calibration and monitoring. Performance gain of UE gap and impact of UE transmission during the UL gap is to be studied and UL gap configuration(s), related UE capability and interruptions are to be specified.

### SUMMARY

In general, example embodiments of the present disclosure provide a solution for UL gap triggering.

In a first aspect, there is provided a processor of user equipment. The processor is configured to perform operations comprising: transmitting to a network a user preference via a first signaling, wherein the user preference indicates a preference of the UE in UL gap configuration; transmitting to the network an UL gap activation request via a second signaling, wherein the UL gap activation request indicates the network that an UL gap activation for the UE is needed; and transmitting to the network an UL gap deactivation request via a third signaling, wherein the UL gap deactivation request indicates the network that an UL gap deactivation for the UE is needed.

In a second aspect, there is provided user equipment. The user equipment comprises a transceiver and a processor. The transceiver is configured to communicate with a network. The processor is communicatively coupled to the transceiver and configured to perform operations comprising: transmitting to a network a user preference via a first signaling, wherein the user preference indicates a preference of the UE in UL gap configuration; transmitting to the network an UL gap activation request via a second signaling, wherein the UL gap activation request indicates the network that an UL gap activation for the UE is needed; and transmitting to the network an UL gap deactivation request via a third signaling, wherein the UL gap deactivation request indicates the network that an UL gap deactivation for the UE is needed.

In a third aspect, there is provided a processor of a base station. The processor is configured to perform operations comprising: receiving from user equipment (UE) a user preference via a first signaling, wherein the user preference indicates a preference of the UE in uplink (UL) gap configuration; receiving from UE an UL gap activation request via a second signaling, wherein the UL gap activation request indicates the base station that an UL gap activation for the UE is needed; and receiving from UE an UL gap deactivation request via a third signaling, wherein the UL gap deactivation request indicates the base station network that an UL gap deactivation for the UE is needed.

In a fourth aspect, there is provided a base station. The base station comprises a transceiver and a processor. The transceiver is configured to communicate with user equipment. The processor is communicatively coupled to the transceiver and configured to perform operations comprising: receiving from user equipment (UE) a user preference via a first signaling, wherein the user preference indicates a preference of the UE in uplink (UL) gap configuration; receiving from UE an UL gap activation request via a second signaling, wherein the UL gap activation request indicates the base station that an UL gap activation for the UE is needed; and receiving from UE an UL gap deactivation request via a third signaling, wherein the UL gap deactivation request indicates the base station network that an UL gap deactivation for the UE is needed.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 shows an example communication network in which example embodiments of the present disclosure can be implemented;

FIG. 2 illustrates a flowchart of a method of uplink gap triggering at user equipment according to some embodiments of the present disclosure;

FIG. 3 illustrates a flowchart of a method of uplink gap triggering at a base station according to some embodiments of the present disclosure;

FIG. 4 illustrates a signaling flow of a method of uplink gap triggering according to some embodiments of the present disclosure, wherein UE assistance information (UAI) is used to transmit the user preference, an UL gap activation request and an UL gap deactivation request;

FIG. 5 illustrates another signaling flow of a method of uplink gap triggering according to some embodiments of the present disclosure, wherein UAI is used to transmit the user preference, an UL gap activation request and an UL gap deactivation request;

FIG. 6 illustrates a further signaling flow of a method of uplink gap triggering according to some embodiments of the present disclosure, wherein UAI is used to transmit the user preference, and Medium Access Control-Control Element (MAC CE) is used to transmit an UL gap activation request and an UL gap deactivation request;

FIG. 7 illustrates a signaling flow of a method of UL gap event triggering according to some embodiments of the present disclosure; and

FIG. 8 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

The terminology used herein is for the purpose of describing particular embodiments only and is not intended to be limiting of example embodiments. For example, as used herein, the singular forms “a”, “an” and “the” are intended to include the plural forms as well, unless the context clearly indicates otherwise. The terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. Moreover, when a particular feature, structure, or characteristic is described in connection with some embodiments, it is submitted that it is within the knowledge of one skilled in the art to affect such feature, structure, or characteristic in connection with other embodiments whether or not explicitly described.

It is also to be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As mentioned above, UL gap was proposed for self-calibration and monitoring for NR radio frequency enhancements for Frequency Range 2 (FR2), e.g., 24.250 GHz and above, which can be also called as mm Wave. UE specific and NW configured gap can be used for general self-calibration and monitoring purposes including UE Tx power management, Coherent UL Multiple Input Multiple Output (MIMO) or other self-calibration and monitoring.

The work item on the UL gap includes two stages, stage 1 and stage 2. In stage 1, performance gain of UE gap over the current baseline solution shall be studied and clearly identified; in stage 2, UL gap configuration(s), related UE capability and interruptions are to be specified.

In addition, some agreement have been reached recently:
The following two UL gap configuration and activation mechanisms are agreed
   #1: UL gap should be explicitly configured and activated/deactivated directly by RRC signaling
   #2: UL gap should be explicitly configured by RRC and activated and deactivated by MAC CE
UL gap should be explicitly activated by NW via signaling
   How can UE indicate the NW UL gap activation is needed?
      Option 1: UE explicitly indicates to NW by signaling
      Option 2: UE implicitly indicate to NW by P-MPR reporting. The exact P-MPR value is FFS.
   Network can activate UL gap without the indication from UE
UL gap should be explicitly deactivated by NW via signaling
   How can UE indicate the NW UL gap deactivation is needed?
      Option 1: UE explicitly indicates to NW by signaling
      Option 2: UE implicitly indicate to NW by [TBD] reporting.
   Network can deactivate UL gap without the indication from UE.
On how can UE indicate to the NW UL gap activation/de-activation is needed:
   UL gap should be explicitly activated by NW via signaling
      How can UE indicate to the NW UL gap activation is needed?
         If needed, UE explicitly indicates to NW by signaling
   UL gap should be explicitly deactivated by NW via signaling
      How can UE indicate to the NW UL gap deactivation is needed?
         If needed, UE explicitly indicates to NW by signaling″

Although the above agreements have been reached, there are still pending issues to be solved for example solutions regarding various aspects of UL gap triggering are still to be specified.

Embodiments of the present disclosure propose a solution for uplink gap triggering. In this solution, a processor of user equipment is configured to perform operations. The operations include transmitting to a network a user preference via a first signaling, wherein the user preference indicates a preference of the UE in uplink (UL) gap configuration. The operations further comprise transmitting to the network an UL gap activation request via a second signaling, wherein the UL gap activation request indicates the network that an UL gap activation for the UE is needed. The operations also comprise transmitting to the network an UL gap deactivation request via a third signaling, wherein the UL gap deactivation request indicates the network that an UL gap deactivation for the UE is needed.

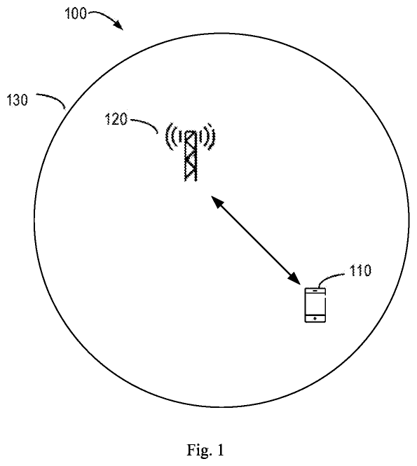

Principle and implementations of the present disclosure will be described in detail below with reference to FIGS. 1-8. FIG. 1 illustrates a network environment 100 in accordance with some embodiments. The network environment 100 may include UE 110 and a base station 110. The base station 120 may provide one or more wireless access cells, for example, 3GPP NR cells, through which the UE 110 may communicate with the base station 120. In some aspects, the base station 120 is a gNB that provides 3GPP New Radio (NR) cell. The air interfaces over which the UE 110 and base station 120 communicate may be compatible with 3GPP TSs such as those that define 5G NR system standards and may occupy frequency bands in Frequency Range 1 (FR1) (e.g., below 7.225 GHZ), Frequency Range 2 (FR2) (e.g., 24.250 GHz and above, also called mmWave), or higher frequency bands (e.g., between 52.6 GHz and 71 GHz or 114.25 GHz).

It may be desired to enhance coverage, signal quality, or UE performance in the frequency ranges above FR1. For example, it may be desired to improve power efficiency or overall system throughput. Some FR2 enhancements may involve operations that should be performed during run-time but may not be compatible with transmission or reception of data or control signals. Due to unavoidable hardware sharing, various identified FR2 enhancements may rely on and benefit from a periodic uplink (UL) gap, during which time the UE can perform these operations (for example, over the air or through an internal loop) without interrupting transmission/reception. Examples of these operations include: power amplifier (PA) efficiency and power consumption operations; transceiver calibration operations; and UL Tx power management operations. Other self-calibration or monitoring operations are not precluded.

PA efficiency and power consumption operations may be performed to calibrate a PA. These operations may include performing periodic measurements of one or more characteristics of the PA including, for example, gain and linearity.

Transceiver calibration operations may be performed to compensate for operational performance variations due to, for example, temperature fluctuations. It may be desired to perform transceiver calibration periodically at runtime in order to compensate for transceiver impairments. A calibration network may also help to maximize beamforming gain of the antenna array, thereby improving FR2 system performance. Typical usage cases of transceiver calibration may include any one or more of PA calibration (Tx), I/Q imbalance (Tx/Rx), local oscillator (LO) leakage (Tx) and DC offset (Rx).

UL Tx power management operations may allow UE to adaptively and efficiently adjust its output power to improve UL coverage or throughput while maintaining compliance with regulatory requirements. Transmit power management may benefit from periodic monitoring of information from the surrounding environment (e.g., body proximity).

At least some of the aforementioned self-calibration and monitoring mechanisms may be generalized as a basic scheme in which the UE 110 sends and receives a calibration signal, either over the air or through another internal loop between transmit (Tx) and receive (Rx) hardware. Since the hardware used for UL transmission is partially shared by self-calibration and monitoring, UL transmission may be interrupted momentarily by such an operation. It may be desired to minimize such disruption by providing a preconfigured UL gap, during which time the UE can perform operations for FR2 RF enhancement, such as calibration and/or measurement (e.g., transceiver calibration and Tx power management). While some embodiments are described as improvements to operation in FR2, they may also be applied to other frequency ranges including ranges above FR2.

The UE 110 may be provided with an UL gap configuration that specifies values such as gap length, gap periodicity, and/or gap location (for example, offset). An offset may define an exact location within each periodicity. The UL gap configuration may be UE-specific and may be provided by the base station 120 using Radio Resource Control (RRC) signaling or Medium Access Control-Control Elements (MAC-CEs)).

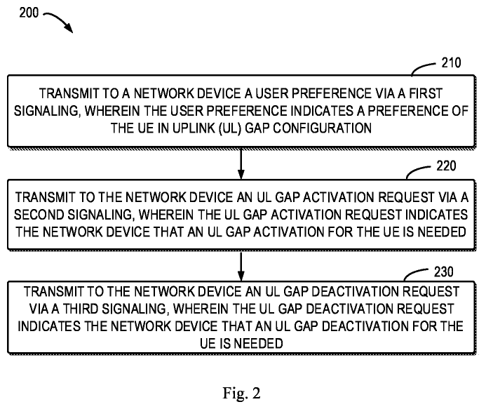

FIG. 2 illustrates a flowchart of a method 200 of uplink gap triggering at user equipment according to some embodiments of the present disclosure. The method 200 can be implemented at a device, for example the UE 110 shown in FIG. 1. It is to be understood that the method 200 may include additional blocks not shown and/or may omit some shown blocks, and the scope of the present disclosure is not limited in this regard. At block 210, the UE 110 transmits to a network device such as the BS 120 a user preference via a first signaling, wherein the user preference indicates a preference of the UE in uplink (UL) gap configuration. The user preference may include preferred gap pattern for the UE 110, for example preference to one or more of gap length, gap periodicity, or gap location (for example, offset). The user preference can be used by the BS 120 to make decision, for on the UL gap configuration for the UE, such as gap periodicity, gap offset, gap length, etc.

In some embodiments, the UE 110 may transmit to the network device such as BS 120 the user preference using UE assisted information (UAI). By means of UAI, it could provide a more reliable user preference transmission.

At block 220, the UE 110 transmits to the network device such as BS 120 an UL gap activation request via a second signaling, wherein the UL gap activation request indicates the network that an UL gap activation for the UE is needed.

In some embodiments, the UE 110 may transmit to the network device such as BS 120 the UL gap activation request using UAI. Similarly, the UAI could provide a more reliable UL gap activation request transmission.

In some embodiments, the UE 110 may transmit to the network device such as the BS 120 the UL gap activation request via MAC CE. By means of MAC CE, it is possible to provide a more fast and reliable UL gap activation request transmission.

At block 230, the UE 110 transmits to the network such as the BS 120 an UL gap deactivation request via a third signaling, wherein the UL gap deactivation request indicates the network that an UL gap deactivation for the UE is needed.

In some embodiments, the UE 110 may transmit to the BS 120 the UL gap deactivation request using UAI. Similarly, the UAI could provide a more reliable UL gap deactivation request transmission.

In some embodiments, the UE 110 may transmit to the BS 120 device the UL gap deactivation request via MAC CE. By means of MAC CE, it is possible to provide a more fast and reliable UL gap deactivation request transmission.

The method 200 can be applied in different solution of UL gap activation/deactivation. In some embodiments, the UE 110 may receive an UL gap activation command from the BS 120 via a RRC signaling. and, receive an UL gap deactivation command from the network device via another RRC signaling. Alternatively, in some embodiments, the UE 110 may receive from the network device such as the BS 120 an UL gap activation command via an MAC CE, and receive from the network device such as the BS 120 an UL gap deactivation command via another MAC CE.

In some embodiments, the UE 110 may receive from the network device an UL gap configuration via an RRC signaling, wherein the UL gap configuration indicates a single UL gap is configured. In such a case, the UE could activate the configured UL gap in response to the reception of the UL gap configuration without a separate UL gap activation command.

In some embodiments, the UE 110 may receive from the network device such as the BS 120 an UL gap configuration via an RRC signaling, wherein the UL gap configuration indicate one or more UL gaps are configured. In such a case, the UE could activate, in response to the reception of the UL gap activation command from the network device via the MAC CE, an UL gap indicated in the UL gap activation command.

In some embodiments, the UE 110 may further transmit to a network device such as the BS 120 UL gap capability information via an RRC signaling. In some examples, the UL gap capability information may comprise one or more of: at least one UL gap supported by UE for power management; configuration of the at least one UL gap supported by UE for power management; or supportability of the mandatory gap for inter-operability test (IOT) purpose.

In some embodiments, the UE 110 may further receive from the network device such as the BS 120 an UL gap configuration via an RRC signaling. The UL gap configuration can be implemented by for example different options. In an option, the UL gap configuration indicates a single UL gap pattern, and thus the UL gap activation request may contain, for example, only an ON indication and the UL gap deactivation request may contain, for example, only an OFF indication. In another option, the UL gap configuration indicates one or more UL gap patterns, and in turn the UL gap activation request may contain indication on an UL gap pattern to be activated and the UL gap deactivation request may contain an OFF indication.

In some embodiments, the UE 110 may perform an event evaluation for UL gap activation based on activation event configuration. The event configuration may include at least one trigger condition. The at least one trigger condition may be based on value of P-MPR indicating whether power management Maximum Power Reduction (P-MPR) is applied. Therefore, the UE 110 may further transmit to the network device such as the BS 120 an event triggered UL gap activation request in response to that any of the at least one trigger condition is met. As an example, the trigger condition includes the value of P-MPR filed being equal to 1. As another example, the trigger condition includes the value of P-MPR filed being greater than 0.

Only for illustrative purposes, Table 1 is given to illustrate four different P-MPR filed values and corresponding measurement quantity value level.

TABLE 1
Mapping of FR2 P-MPR

| Reported value | Measured quantity value | Unit |
|---|---|---|
| P-MPR_00 | 3 ≤ P-MPR < 6 | dB |
| P-MPR_01 | 6 ≤ P-MPR < 9 | dB |
| P-MPR_02 | 9 ≤ P-MPR < 12 | dB |
| P-MPR_03 | P-MPR ≥12 | dB |

In Table 1, there are four reported values, P-MPR_00 (“00”), P-MPR_01 (“01”), P-MPR_02 (“10”), P-MPR_03 (“11”), which are respectively corresponding to four different measurement quantity levels as illustrated.

For Table 1, if the value of P-MPR field is equal to 1, i.e., the reported value of the P-MPR (or the index of the P-MPR) is “01”, it means the measured real P-MPR value is equal to or higher than 6 dB. If the value of P-MPR filed being is than 0, it means the measured real P-MPR value is equal to or higher than 3 dB. Therefore, the trigger conditions can, alternatively, include the measured P-MPR value being equal to or higher than 6 dB; or the trigger conditions can also include the measured P-MPR value being equal to or higher than 3 dB.

In some embodiments, the P-MPR contains four different values corresponding to four different measured quantity levels respectively and the four different values can be associated with at least two trigger conditions for different UL gap configurations.

In some embodiments, a value of the P-MPR field corresponding to a lower measured quantity level is used to trigger an activation request for UL gap configuration with lower overhead, a value of the P-MPR field corresponding to a higher measured quantity level is used to trigger an activation request for UL gap configuration with higher overhead.

For P-MPR filed values in the Table 1, report of P-MPR_00 can be an activation condition for UL gap pattern with overhead of, for example, 2.5%, wherein the overhead is defined as the ratio of UGL (UL gap length) and UGRP (UL gap repetition periodicity). Report of P-MPR_01, 02 and 03 (i.e., the filed value would be, for example, “01”, “10” and “11”) can be an activation condition for UL gap pattern with overhead of, for example, 5%. It shall be noted that the link between P-MPR index and the UL gap pattern is only an example and the present disclosure is not limited thereto. Alternatively, the trigger conditions can also include triggering the two different UL gap patterns based whether the measured P-MPR value is equal to or higher than 6 dB.

In some embodiments, the UE 110 may perform an event evaluation for UL gap deactivation based on deactivation event configuration, wherein the deactivation event configuration includes at least one trigger condition for UL gap deactivation. The UE 110 may transmit to the network device such as BS 120 an event triggered UL gap deactivation request in response to that any of the at least one trigger condition is met.

In some embodiments, the at least one trigger condition comprises one or more of: a buffer status value in a buffer status report being smaller than a pre-configured value; a powerhead value in a powerhead report being greater than a pre-configured threshold and P-MPR >0; a powerhead value in a powerhead report being greater than a pre-configured threshold the P-MPR field being set to 1; a Reference Signal Received Power (RSRP) value reported at layer 1 being greater than a pre-configured threshold; or a RSRP value reported at layer 3 being greater than a pre-configured threshold.

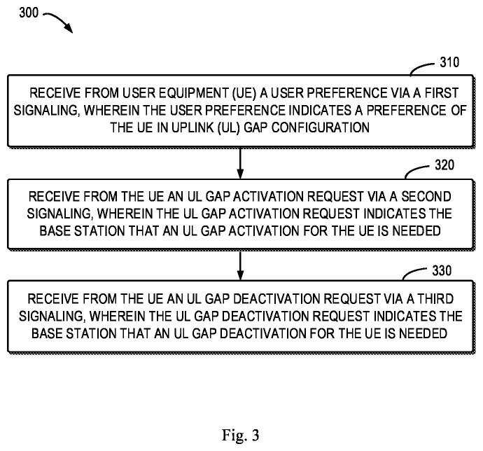

FIG. 3 illustrates a flowchart of the method of uplink gap triggering at a base station (BS) according to some embodiments of the present disclosure. The method 300 can be implemented at a network device, for example the BS 120 shown in FIG. 1. It is to be understood that the method 300 may include additional blocks not shown and/or may omit some shown blocks, and the scope of the present disclosure is not limited in this regard.

At block 310, the BS 120 receives from UE 110 a user preference via a first signaling, wherein the user preference indicates a preference of the UE in UL gap configuration. The user preference may include preferred gap pattern for the UE 110, for example preference to one or more of gap length, gap periodicity, or gap location (for example, offset). The user preference can be used by the BS 120 to make decision, for on the UL gap configuration for the UE, such as gap periodicity, gap offset, gap length, etc.

In some embodiments, the BS 120 may receive the user preference in UE assisted information (UAI). By means of UAI, it could provide a more reliable information transmission.

At block 320, the BS 120 receives from the UE 110 an UL gap activation request via a second signaling, wherein the UL gap activation request indicates the base station that an UL gap activation for the UE is needed.

In some embodiments, the BS 120 may receive from the UE 110 the UL gap activation request in UAI. Similarly, the UAI could provide a more reliable UL gap activation request transmission.

In some embodiments, the BS 120 may receive from the UE the UL gap activation request via a MAC CE. By means of MAC CE, it is possible to provide a faster and reliable UL gap activation request transmission.

At block 330, the BS 120 receives from UE 110 an UL gap activation request via a third signaling, wherein the UL gap deactivation request indicates the base station that an UL gap deactivation for the UE is needed.

In some embodiments, the BS 120 may receive from the UE 110 the UL gap deactivation request in another UAI. Similarly, the UAI could provide a more reliable UL gap deactivation request transmission.

In some embodiments, the BS 120 may receive from the UE 110 the UL gap deactivation request via another MAC CE. By means of MAC CE, it is possible to provide a more fast and reliable UL gap deactivation request transmission.

The method 300 can be applied in different solution of UL gap activation/deactivation. In some embodiments, the BS 120 may transmit an UL gap activation command to the UE 110 via a radio resource control (RRC) signaling, and transmit an UL gap deactivation command to the UE 110 via another RRC signaling. Alternatively, in some embodiments, the BS 120 may transmit an UL gap activation command to the UE 110 via an MAC CE and transmit an UL gap deactivation command to the UE 110 via another MAC CE.

In some embodiments, the BS 120 may transmit an UL gap configuration to the UE 110 via an RRC signaling, wherein the UL gap configuration indicates a single UL gap is configured. In such case, the BS 120 may transmit the UL gap configuration is used to activate the configured UL gap without a separate UL gap activation command.

In some embodiments, the BS 120 may transmit an UL gap configuration to the UE 110 via an RRC signaling, wherein the UL gap configuration indicate one or more UL gaps are configured. In such a case, the BS 120 may further determine an UL gap to be activated from the one or more UL gaps, and send to the UE 110 an UL gap activation command containing the UL gap to be activated to instruct the UE to activate the UL gap.

In some embodiments, the BS 120 may further receive from the UE 110 UL gap capability information via an RRC signaling. The UL gap capability comprises one or more of: at least one UL gap supported by UE for power management; configuration of the at least one UL gap supported by UE for power management; or supportability of the mandatory gap for IOT purpose.

In some embodiments, the BS 120 may further transmit an UL gap configuration to the UE 110 via an RRC signaling and the UL gap configuration indicates, for example, only one UL gap pattern. In such a case, the UL gap activation request may contain, for example, only an ON indication and the UL gap deactivation request may contain an OFF indication.

In some embodiments, the BS 120 may further transmit an UL gap configuration to the UE via for example an RRC signaling, and the UL gap configuration indicates one or more UL gap patterns. In such a case, the UL gap activation request may contain, for example, only an indication on an UL gap pattern to be activated and the UL gap deactivation request may contain, for example, only an OFF indication.

In some embodiments, the BS 120 may further receive from the UE an event triggered UL gap activation request in response to that any of the at least one event is met. The event triggered UL gap activation request may be triggered based on activation event configuration and the event configuration may include a trigger condition based on value of P-MPR indicating power management Maximum Power Reduction (P-MPR) is applied. For example, the trigger condition includes the value of P-MPR filed being equal to 1. As another example, the trigger condition includes the value of P-MPR filed being greater than 0. For P-MPR mapping illustrated Table 1, alternatively, the trigger conditions can also include the measured P-MPR value is equal to or higher than 6 dB; or the trigger conditions can also include the measured P-MPR value is equal to or higher than 3 dB.

In some embodiments, the P-MPR contains four different values corresponding to four different measured quantity levels respectively and the four different values can be associated with at least two trigger conditions for different UL gap configurations. In such an case, a value of the P-MPR field corresponding to a lower measured quantity level is used to trigger an activation request for UL gap configuration with lower overhead, a value of the P-MPR field corresponding to a higher measured quantity level is used to trigger an activation request for UL gap configuration with higher overhead.

An example table is given in Table 1 and in such a case, report of P-MPR_00 can be an activation condition for UL gap pattern with overhead of for example 2.5% and report of P-MPR_01, 02 and 03 can be an activation condition for UL gap pattern with overhead of 5%. For P-MPR mapping illustrated Table 1, alternatively, the trigger conditions can also include triggering the two different UL gap patterns based whether the measured P-MPR value is equal to or higher than 6 dB.

In some embodiments, the BS 120 may further receive from the UE an event triggered UL gap deactivation request. The event triggered UL gap deactivation request may be triggered by the UE 110 based on at least one trigger condition for UL gap deactivation, which is configured by the BS 120. The at least one trigger condition includes for example, one or more of: a buffer status value in a buffer status report being smaller than a pre-configured value; a powerhead value in a powerhead report being greater than a pre-configured threshold and P-MPR field >0; a powerhead value in a powerhead report being greater than a pre-configured threshold the P-MPR field being set to 1; a Reference Signal Received Power (RSRP) value reported at layer 1 being greater than a pre-configured threshold; or a RSRP value reported at layer 3 being greater than a pre-configured threshold.

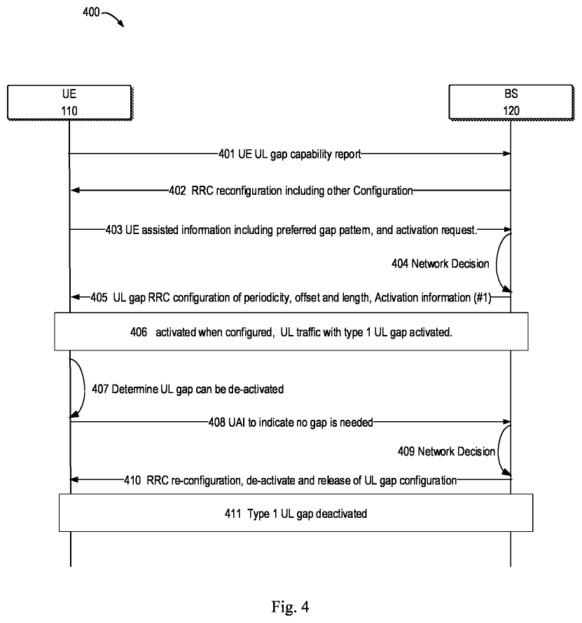

For illustrative purposes, FIGS. 4 to 7 illustrate signaling flows of UL gap trigger according to some embodiments of the present disclosure. Hereinafter, reference will be made to these figures to describe these embodiments.

FIG. 4 illustrates a signaling flow of a method of uplink gap triggering according to some embodiments of the present disclosure. In these embodiments, UAI is used to transmit the user preference, UL gap activation request and UL gap deactivation request. At 401, the UE 110 may first transmit a UL gap capability report to the BS 120. This report may be included in one message or a plurality of messages.

The UL gap capability report may provide an indication of capabilities of the UE 110 with respect to performing transceiver calibration and monitoring within an UL gap. For example, the UL gap capability report may indicate whether the UE 110 support UL gap for Tx power. The UL gap capability report may also indicate supported UL gap configuration. If all gap patterns are mandatory for UE capable of UL gap, then this information may not be needed. The UE 110 may further indicate if the mandatory gap pattern is supported or not for inter-operability test purpose.

At 402, the base station 120 may provide the UE 110 with RRC reconfiguration message including other configurations, for example otherConfig. as specified in 5.3.5.9, of 38.331.

At 403, the UE 110 may provide the base station 120 with UE assisted information. The UE assisted information may include user preference, for example preferred gap pattern, and may further include an activation request. The UAI can indicate one or more UL gap preferred configurations.

At 404, the base station 120 may make a network decision to determine the gap periodicity, gap offset, gap length, and activation information based on the UL gap capability, user preference, etc.

At 405, the BS 120 may transmit to the UE 110 configuration information and activation information for one UL gap configuration. The configuration information may be provided by RRC signaling and include an RRC information element that defines a periodicity, offset, and length associated with the UL gap configuration.

In the example process, the RRC configuration contains only one UL gap and the activation information may be transmitted together with the UL gap RRC configuration. Thus, the UE 110 may activate the UL gap at the same time, as illustrated at 406. After the UL gap is activated, the UE 110 may engage in ongoing UL traffic with the type 1 UL gap configuration activated.

At 407, the UE 110 may determine UL gap can be de-activated. At 408, the UE 110 may send to the base station 120 UAI, to indicate no gap is needed. In response to reception of the UAI, the base station 120 may make a network decision at 409 and may further transmit to the UE 110 with RRC reconfiguration information to deactivate UL gap, and release UL gap configuration at 410. When the UE 110 receives such an RRC reconfiguration information, it will deactivate Type 1 UL gap, and release UL gap configuration as illustrated at 411.

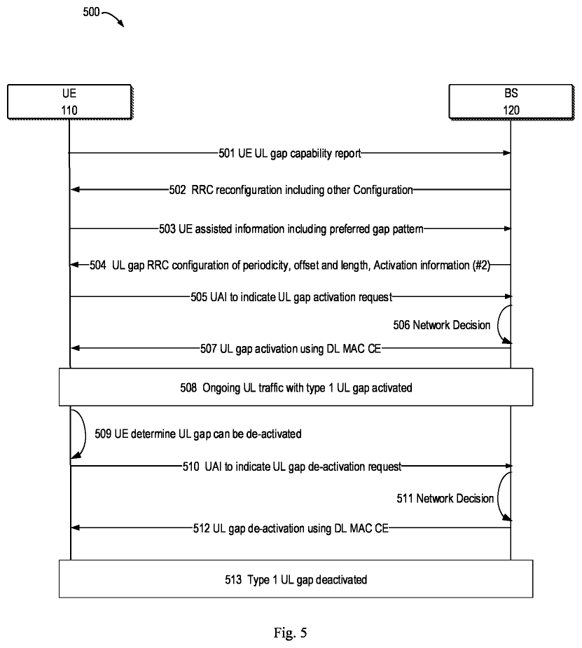

FIG. 5 illustrates another signaling flow of a method of uplink gap triggering according to some embodiments of the present disclosure. In these embodiments, UAI is used to transmit the user preference, UL gap activation request and UL gap deactivation request. The signaling flow illustrated in FIG. 5 is similar to that in FIG. 4 but the UL gap activation/deactivation command use MAC CE.

As illustrated in FIG. 5, at 501, the UE 110 may transmit a UL gap capability report. This report may be included in one message or a plurality of messages. Similarly, the UL gap capability report may provide an indication of capabilities of the UE 110 with respect to performing transceiver calibration and monitoring. For example, the UL gap capability report may indicate whether the UE 110 support UL gap for Tx power, supported UL gap configuration, the mandatory gap pattern is supported or not for inter-operability test purpose. If all gap patterns are mandatory for UE capable of UL gap, then supported UL gap configuration may not be needed.

At 502, the base station 120 may provide the UE 110 with RRC reconfiguration information for one or more UL gap configurations, similar to 402 in FIG. 4.

At 503, the UE 110 may send to the base station 120 with UE assisted information (UAI). The UE assisted information may include preferred gap pattern, and one or more UL gap preferred configurations can be indicated.

At 504, the base station 120 may transmit to the UE 110 with UL gap RRC configuration information and activation information. The configuration information may be provided by RRC signaling and include an RRC information element that defines a periodicity, offset, and length associated with the UL gap configuration. The RRC configuration may indicate one or more UL gaps, and in such cases, the base station 120 further transmit additional MAC CE activation/deactivation command to instruct to activate or deactivate a UL gap.

At 505, the UE 110 may send to the base station 120 a UAI carrying UL gap activation request. The UAI carrying the UL gap activation request is used to inform the BS 120 that the UE 110 needs a UL gap. In some embodiments, For example, when only one UL gap pattern is configured, the UAI may only carry for example an ON indication. In other embodiments, when multiple UL gap patterns are configured, UAI indicate which UL gap pattern the UE request to activate. Similarly, the UE 110 may use another UAI containing OFF indication to inform the BS 110 that the UL gap is not needed, so as to deactivate the UL gap.

At 506, the base station 120 may make a network decision and decide to activate the UL gap and provide the UE 110 with UL gap activation command using DL MAC CE.

At 508, the UE 110 activates the UL gap and may engage in ongoing UL traffic with the type 1 UL gap configuration activated.

At 509, the UE 110 may determine UL gap can be deactivated and then transmit, at 510, to the base station 120 another UAI to indicate UL gap deactivation request. When receiving the UAI, the base station 120 may make a network decision at 511 to deactivate the UL gap and transmit to the UE 110 a UL gap deactivation command using DL MAC CE at 512. At 513, the UE 110 will deactivate Type 1 UL gap, and release UL gap configuration.

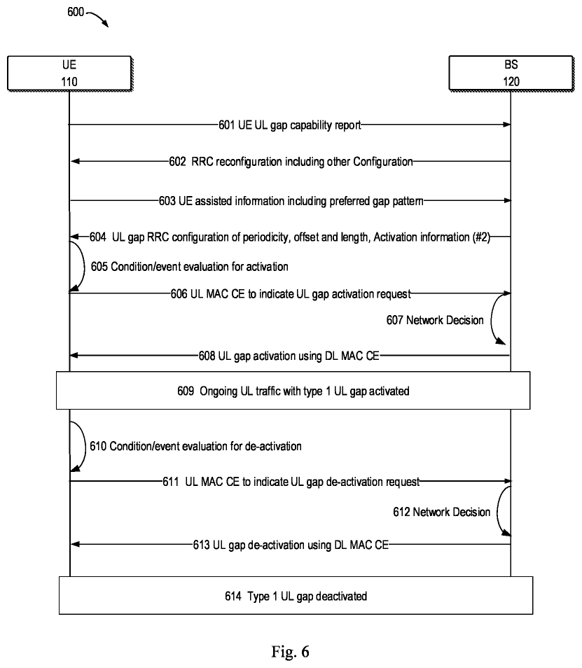

FIG. 6 illustrates a further signaling flow of a method of uplink gap triggering according to some embodiments of the present disclosure. Similar to FIG. 4, UAI is used to transmit the user preference, but MAC CE is used to transmit a UL gap activation request and a UL gap deactivation request.

As illustrated, at 601, the UE 110 may transmit a UL gap capability report. This report may be included in one message or a plurality of messages. The UL gap capability report can be similar to those described with FIGS. 4 and 5 and thus detailed are omitted here for simplification purposes.

At 602, the base station 120 may transmit the UE 110 RRC reconfiguration information. The RRC reconfiguration information may include one or more UL gap configurations and some other configuration information. RRC reconfiguration information can be similar to those described with FIGS. 4 and 5 and thus detailed are omitted here for simplification purposes.

At 603, the UE 110 may transmit user preference to the base station 120 using UAI. The UAI may include one or more preferred gap patterns for the UE 110.

At 604, the base station 120 may transmit UL gap RRC configuration information and activation information to the UE 110. The configuration information may be transmitted by RRC signaling and include an RRC information element that defines a periodicity, offset, and length associated with the UL gap configuration. The RRC configuration can include one or multiple UL gap configurations, and the UE 110 may request one of the UL gap configurations using a UL MAC CE.

At 605, the UE 110 may make a condition or event evaluation for activation based on UL gap trigger conditions or events to determine whether a UL gap shall be triggered.

In some embodiments, the UE 110 may trigger a UL gap activation request when the P-MPR reduction is needed to meet maximum permissible Exposure (MPE) requirement, including for example, peak Effective Isotropic Radiated Power (EIRP), UL duty cycle, UL buffer status, link condition and power control algorithm, and etc.

In some embodiments, the UE 110 may trigger a UL gap activation request for Tx power management with a different UL gap pattern (in case multiple UL gap patterns are RRC configured) due to large temperature drift due to UE activity and/or environment.

In some embodiments, the UE 110 may trigger a UL gap activation request if the UE observe P-MPR is needed to meet MPE during ongoing transmission.

In some embodiments, additional or alternative activation event configuration can be defined. When UL gap is configured and not activated, if any of the addition conditions is met, the UE 110 can transmit an UL MAC CE to request gap activation.

In some embodiments, the UE 110 may determine whether to trigger the UL gap activation request based on the value of P-MPR of P-MPR. For example, the UE 110 may trigger the UL gap activation request when the P-MPR field is 1. In Rel15, the “P” field i.e. two bits reported by the UE 110, indicate P-MPR is applied. If mpe-Reporting-FR2 is configured and the Serving Cell operates on FR2, the MAC entity shall set this field to 0 if the applied P-MPR value, to meet MPE requirements, as specified in 3GPP TS 38.101-2, and set to 1 otherwise. In 3GPP TS 38.133 this filed is less than P-MPR_00 if the applied P-MPR value, to meet MPE requirements and set to 1 otherwise.

In some embodiments, the UE 110 may trigger the UL gap activation request if mpe-Reporting-FR2 is configured, P-MPR report is greater than 0. In addition, the UE 110 may trigger the UL gap activation request based on potentially link between P-MPR index and UL gap pattern. For example, for the above-mentioned Table 1, different conditions can be linked to each UL gap configuration triggering. For example, report of P-MPR_00 can be activation condition for UL gap pattern with overhead, defined as the ratio of UGL (UL gap length) and UGRP (UL gap repetition periodicity), of 2.5%, and report of other P-MPR, including for example, P-MPR_01, 02 and 03 can be activation condition for UL gap pattern with overhead of 5%. It shall be noted that the link between P-MPR index and the UL gap pattern is only an example and the present disclosure is not limited thereto.

At 606, the UE 110 may transmit the base station 120 an UL MAC CE to indicate UL gap activation request when it determines any of the above-mentioned trigger conditions is met. At 607, the base station 120 may make a network decision to activate the UL gap and transmit, at 608, the UE 110 a UL gap activation command using DL MAC CE. At 609, the UE 110 activates the UP gap and starts UL traffic with the type 1 UL gap configuration activated.

At 610, the UE 110 may make a condition or event evaluation for deactivation. In some embodiments, when the UL gap trigger condition is not met, the UE 110 may determine to deactivate the UL gap.

In some embodiments, additional or alternative deactivation event configuration can be further defined. The deactivation condition or event may be based on for example BSR, PHR, Layer 1 Reference Signal Received Power (L1-RSRP), or Layer 3 Reference Signal Received Power (L3-RPRP).

For example, the UE 110 may determine to deactivate the UL gap if the value reported in BSR is smaller than pre-configured threshold. Additionally or alternatively, the UE 110 may determine to deactivate the UL gap if powerhead room (PHR) is greater than a pre-configured threshold and P-MPR field >0 or P-MPR field is set to 1 since this implies that even after MPR and P-MPR, still additional PHR is available, i.e., cell center. For example, the PHR can be determined based on the following equation:

$$PHR = ( P\_c , max - max ( MPR , P - MPR ) ) - Pt ,$$

wherein P_c, max denotes the maximum power of the cell;
MPR denotes the allowed maximum power reduction;
P-MRP denotes the power management maximum power reduction; and
Pt denotes current Tx power based on power control.

Additionally or alternatively, the UE 110 may determine to deactivate the UL gap if the RSRP value reported at layer 1 being greater than a pre-configured threshold. Additionally or alternatively, a RSRP value reported at layer 3 being greater than a pre-configured threshold (cell center).

At 611, the UE 110 may transmit to the base station 120 an UL MAC CE to indicate UL gap activation request if it determines to deactivate the UL gap based on the result of the condition/event condition in 610. At 612, the BS 120 may make a network decision to deactivate the UL gap and transmit a UL gap deactivation command to the UE 110 using DL MAC CE at 613. The UE 110 may receive the UL gap deactivation command and deactivate Type 1 UL gap as instructed at 614.

It shall be noted that UL gap trigger conditions/events and UL gap deactivation conditions/events as described above may also be applied to the signaling chart as described with FIG. 5. For example, condition/event evaluation for UL gap trigger can be conducted between 504 and 505 and condition/event evaluation for UL gap trigger can be conducted at 509.

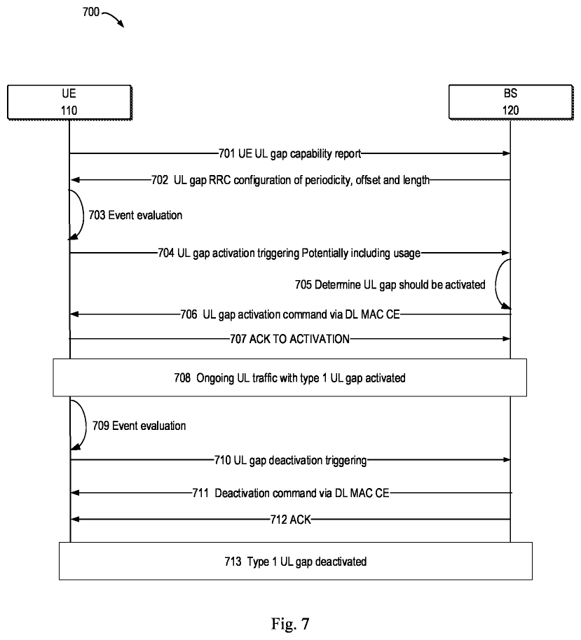

FIG. 7 illustrates a further signaling flow of a method of UL gap event triggering according to some embodiments of the present disclosure. In FIG. 7, no user preference is mentioned, however the present disclosure is not limited thereto and user preference similar to those described hereinabove can be transmitted from the UE 110 to the base station 120 as well.

As illustrated in FIG. 7, at 701, the UE 110 may transmit a UL gap capability report. This report may be included in one message or a plurality of messages. At 702, the base station 120 may provide transmit RRC reconfiguration information on one or more UL gap configurations to UE 110. The RRC reconfiguration information may include other configuration information.

At 703, the UE 110 may make an event evaluation based on UL gap trigger conditions or events to determine whether a UL gap shall be triggered.

Similar to those described with reference to FIG. 6, the UE 110 may trigger a UL gap activation request based on the P-MPR, temperature drift, P-MPR during ongoing transmission. In addition to the above trigger conditions or events, additional or alternative activation event configuration can be defined, for example, the additional or alternative trigger condition or event may be based on the value of P-MPR of P-MPR, potentially link between P-MPR index and UL gap pattern. These trigger or activation conditions or events are similar to those described with reference to FIG. 6 and thus detailed description is omitted herein.

At 704, the UE 110 may provide the base station 120 an UL gap activation triggering message. The UE 110 may send event trigger UL gap activation request through Physical Uplink Control Channel (PUCCH), or using existing Physical Uplink Shared Channel (PUSCH) configuration, for example configured grant or dynamic grant.

At 705, the base station 120 may decide UL gap should be activated and at 824, transmit to the UE 110 a UL gap activation command at 706 via MAC CE or Downlink Control information (DCI) in PDCCH. After the UE 110 receives the UL gap activation command, it activates the UL gap and sends an acknowledge to the base station 108 at 707 and starts UL traffic with type 1 UL gap configuration activated at 708.

At 709, the UE 110 may make an event evaluation for UL gap deactivation. In some embodiments, when the UL gap trigger condition is not met, the UE 110 may determine to deactivate the UL gap. In addition, similar to 610 in FIG. 6, additional or alternative deactivation event configuration can be further defined. The deactivation condition or event may be based on for example BSR, PHR, Layer 1 Reference Signal Received Power (L1-RSRP), or Layer 3 Reference Signal Received Power (L3-RPRP). These deactivation conditions or events are similar to those described with reference to FIG. 6 and thus detailed description is omitted herein.

At 710, the UE 110 may transmit to the base station 120 a UL gap deactivation triggering request when the UE 110 determines that the UL gap is not needed. At 710, the base station 120 may transmit to the UE 110 a deactivation command through a signaling to de-activate the UL gap. The deactivation command can be carried by a MAC CE or DCI. The UE 110 sends an acknowledgement to the base station 108 at 712 and deactivates the UL gap at 713.

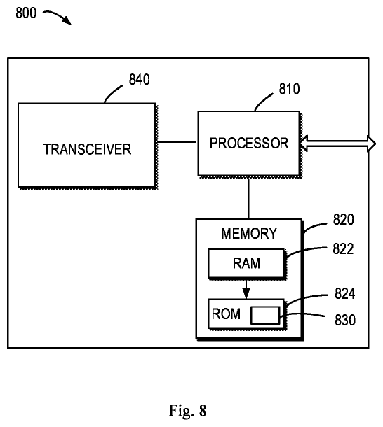

FIG. 8 is a simplified block diagram of a device 800 that is suitable for implementing embodiments of the present disclosure. For example, the BS 120 and the UE 110 can be implemented by the device 800. As shown, the device 800 includes a processor 810, a memory 820 coupled to the processor 810, and a transceiver 840 coupled to the processor 810.

The transceiver 840 is for bidirectional communications. The transceiver 840 is coupled to at least one antenna to facilitate communication. The transceiver 840 can comprise a transmitter circuitry (e.g., associated with one or more transmit chains) and/or a receiver circuitry (e.g., associated with one or more receive chains). The transmitter circuitry and receiver circuitry can employ common circuit elements, distinct circuit elements, or a combination thereof.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The program 830 may be stored in the ROM 824. The processor 810 may perform any suitable actions and processing by loading the program 830 into the RAM 822.

The embodiments of the present disclosure may be implemented by means of the program 830 so that the device 800 may perform any process of the disclosure as discussed with reference to FIGS. 2-7. The embodiments of the present disclosure may also be implemented by hardware or by a combination of software and hardware.

The present disclosure also provides at least one computer program product tangibly stored on a non-transitory computer readable storage medium. The computer program product includes computer-executable instructions, such as those included in program modules, being executed in a device on a target real or virtual processor, to carry out one or more of the method 200 as described above with reference to FIG. 2, the method 300 as described above with reference to FIG. 3. Additionally or alternatively, the computer-executable instructions being executed in a device on a target real or virtual processor, can also carry out one or more of the signaling flow as described above with reference to FIGS. 4 to 7.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A processor of user equipment (UE) configured to perform operations comprising:
transmitting, to a network, a user preference via a first signaling, wherein the user preference indicates a preference of the UE for an uplink (UL) gap configuration;
transmitting, to the network, a UL gap activation request via a second signaling, wherein the UL gap activation request indicates to the network that a UL gap activation for the UE is needed; and
transmitting, to the network, a UL gap deactivation request via a third signaling, wherein the UL gap deactivation request indicates to the network that a UL gap deactivation for the UE is needed.

2. The processor of claim 1, wherein transmitting to the network device the user preference via the first signaling comprises:
transmitting the user preference using UE assisted information (UAI).

3. The processor of claim 1, wherein transmitting the UL gap activation request via the second signaling comprises transmitting the UL gap activation request using UAI; and
wherein transmitting the UL gap deactivation request via the third signaling comprises transmitting the UL gap deactivation request using another UAI.

4. The processor of claim 1, wherein transmitting the UL gap activation request via the second signaling comprises transmitting the UL gap activation request via a media access control (MAC) control element (CE); and
wherein transmitting the UL gap deactivation request via the third signaling comprises transmitting the UL gap deactivation request via another MAC CE.

5. The processor of claim 3, wherein the operations further comprise one or more of:
receiving a UL gap activation command from the network via a radio resource control (RRC) signaling; or
receiving a UL gap deactivation command from the network via another RRC signaling.

6. The processor of claim 4, wherein the operations further comprise one or more of:
receiving a UL gap activation command from the network via a MAC CE; or
receiving a UL gap deactivation command from the network via another MAC CE.

7. The processor of claim 5, wherein the operations further comprise:
receiving, from the network, a UL gap configuration via an RRC signaling, wherein the UL gap configuration indicates a single UL gap is configured; and
activating the configured UL gap in accordance with determination of the reception of the UL gap configuration.

8. The processor of claim 6, wherein the operations further comprise:
receiving, from the network, a UL gap configuration via an RRC signaling, wherein the UL gap configuration indicate one or more UL gaps are configured;
activating, in accordance with determination of the reception of the UL gap activation command from the network via the MAC CE, a UL gap indicated in the UL gap activation command.

9. The processor of claim 1, wherein the operations further comprise:
transmitting, to the network, device UL gap capability information via an RRC signaling, wherein the UL gap capability information comprise one or more of:
at least one UL gap supported by the UE for power management;
configuration of the at least one UL gap supported by the UE for power management; or
supportability of the mandatory gap for an inter-operability test (IOT).

10. The processor of claim 1, wherein the operations further comprise:
receiving, from the network, a UL gap configuration via an RRC signaling, wherein the UL gap configuration indicates a single UL gap pattern; and
wherein the UL gap activation request contains an ON indication and the UL gap deactivation request contains an OFF indication.

11. The processor of claim 1, wherein the operations further comprise:
receiving, from the network, a UL gap configuration via an RRC signaling, wherein the UL gap configuration indicates one or more UL gap patterns, and
wherein the UL gap activation request contains indication on an UL gap pattern to be activated and the UL gap deactivation request contains an OFF indication.

12. The processor of claim 4, wherein the operations further comprise:
performing an event evaluation for UL gap activation based on an event configuration, wherein the event configuration includes at least one trigger condition based on a value of a power management Maximum Power Reduction (P-MPR) field indicating whether power management Maximum Power Reduction (P-MPR) is applied; and
transmitting, to the network, device an event triggered UL gap activation request in response to the at least one trigger condition being met.

13. The processor of claim 12, wherein the trigger condition includes the value of the P-MPR field being equal to 1.

14. The processor of claim 12, wherein the trigger condition includes the value of the P-MPR field being greater than 0.

15. The processor of claim 14, wherein the P-MPR field contains four different values corresponding to four different measured quantity levels respectively and the four different values can be associated with at least two trigger conditions for different UL gap configurations.

16. The processor of claim 14, wherein the value of the P-MPR field corresponding to a lower measured quantity level is used to trigger an activation request for UL gap configuration with lower overhead, the value of the P-MPR field corresponding to a higher measured quantity level is used to trigger an activation request for UL gap configuration with higher overhead.

17. The processor of claim 12, wherein the operations further comprise:
performing an event evaluation for UL gap deactivation based on a deactivation event configuration, wherein the deactivation event configuration includes at least one trigger condition for UL gap deactivation; and
transmitting, to the network, an event triggered UL gap deactivation request in response to the at least one trigger condition being met, wherein the at least one trigger condition comprises one or more of:
a buffer status value in a buffer status report being smaller than a pre-configured value;
a powerhead value in a powerhead report being greater than a pre-configured threshold and the P-MPR field >0;
a powerhead value in a powerhead report being greater than a pre-configured threshold and the P-MPR field being set to 1;
a Reference Signal Received Power (RSRP) value reported at layer 1 being greater than a pre-configured threshold; or
a RSRP value reported at layer 3 being greater than a pre-configured threshold.

18. A user equipment (UE), comprising:
a transceiver configured to communicate with a network; and
a processor communicatively coupled to the transceiver and configured to perform operations comprising:
transmitting, to the network, a user preference via a first signaling, wherein the user preference indicates a preference of the UE for an uplink (UL) gap configuration;
transmitting, to the network, a UL gap activation request via a second signaling, wherein the UL gap activation request indicates to the network that a UL gap activation for the UE is needed; and
transmitting, to the network, a UL gap deactivation request via a third signaling, wherein the UL gap deactivation request indicates to the network that a UL gap deactivation for the UE is needed.

19. A processor of a base station configured to perform operations comprising:
receiving from a user equipment (UE) a user preference via a first signaling, wherein the user preference indicates a preference of the UE for an uplink (UL) gap configuration, receiving, from the UE, a UL gap activation request via a second signaling, wherein the UL gap activation request indicates to the base station that a UL gap activation for the UE is needed; and
receiving, from the UE, a UL gap deactivation request via a third signaling, wherein the UL gap deactivation request indicates to the base station that a UL gap deactivation for the UE is needed.

20. (canceled)
